(19) United States
(12) Patent Application Publication
(10) Pub. No.: US 2007/0006685 A1
(43) Pub. Date: Jan. 11, 2007

(54) Can opener with tab removing device

(76) Inventors: Joe Yiu-Cho Fok, Mountain View, CA (US); Fuk Yuen Ma, Hong Kong (HK)

Correspondence Address: JOE FOK & MA FUK YUEN, 13250 FRANKLIN AVE., MOUNTAIN VIEW, CA, 94040, US

(21) Appl. No.: 11/176,898

(22) Filed: Jul. 8, 2005

(51) Int. Cl. B67B 7/16

(52) U.S. Cl. 81/3.55

(57) ABSTRACT

A can opener combined with lift-off and removing tab, lid or cap of beverage bottle and can.

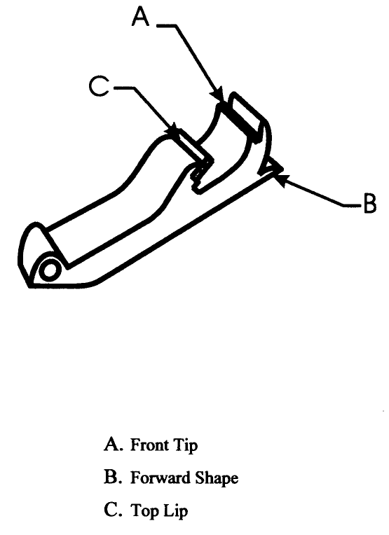

### BACKGROUND OF THE INVENTION

Soft drink bottles, beer bottles, and the like are often provided with a “twist-off” cap. The consumer removes the cap, and many beverage cans are presently provided with lift-off tabs. Such tabs include a ring adapted to be manually grasped whereby the tab may be lifted from the top of the can and then pivoted to expose the opening in the top of the can. Such ring-type tabs are difficult to rise off the can top. This is particularly true in the case of men having stubby fingers, women easily to broken their long nails, and most children, such persons having a problem in inserting their fingers beneath the ring as a prerequisite to its removal.

To solve the above problems, our invention provided relatively easily openers for all lift-off tab can. To applicant's knowledge, however, there has not been heretofore provided an opener for the lift-off and remove tab of a can, much less a combined opener for a lift-off tab of a can.

The embodiments of the invention in which an exclusive property or privilege is claimed are defined as follows:

1. A handle bar with small opening at the tip at the front of the opener call “Front Tip”, it's for clamping the tab or lip upwardly to removing and hold the tab or lip away from the container.

2. A bottom pointed forward shape at the middle from the opener “Forward Shape” are for open circular lid beverage containers; by placed on top of the lid and let the opener ramp push again the container, raise the end of the handle to press open the circular lip.

3. The top upper part pointed lip of the opener is “Top Lip”, it is to push and privets the lever tab, than use the “Front Tip” to removing and hold the tab or lip away from the container for cap opener with multiple-function for beverage containers of the type.
